(19) United States
(12) Patent Application Publication
(10) Pub. No.: US 2007/0274323 A1
(43) Pub. Date: Nov. 29, 2007

(54) USER ACCESS CONTROL METHOD AND APPARATUS IN BUS NETWORK AND BUS NETWORK SYSTEM

(75) Inventor: Seiho Itano, Tokyo (JP)

Correspondence Address: INTELLECTUAL PROPERTY / TECHNOLOGY LAW, PO BOX 14329, RESEARCH TRIANGLE PARK, NC, 27709, US

(73) Assignee: ALLIED TELESIS HOLDINGS K.K., Tokyo (JP)

(21) Appl. No.: 11/751,001

(22) Filed: May 18, 2007

(30) Foreign Application Priority Data
May 23, 2006 (JP) 2006-143128

(51) Int. Cl. H04L 12/56

(52) U.S. Cl. 370/395.53

(57) ABSTRACT

A method and apparatus capable of implementing user access control in a bus network at a low cost, and a bus network system in which low-cost security is implemented. A value of an FCS field in an Ethernet frame transmitted between a client U1 that is permitted to communicate with a server S among multiple clients U1 to U5 connected to a bus network and the server S is reversibly converted so that the Ethernet frame is converted into an FCS error frame. The value of the FCS field in the Ethernet frame converted into the FCS error frame and transmitted is restored to the original FCS value.

### CROSS-REFERENCE TO RELATED APPLICATION

This application claims priority under 35 USC §119 of Japanese Patent Application No. 2006-143128 filed on May 23, 2006

### BACKGROUND OF THE INVENTION

1. Field of the Invention

The present invention relates to the security of a bus network and, in particular, to a user access control method and a user access control apparatus and a bus network system that are useful in a transceiver media converter in a transceiver repeater network and is capable of controlling access by clients to a server in a bus network at a lower cost.

2. Description of the Related Art

A bus network is a network topology in which multiple terminals are connected to a single cable called a bus B, as shown in FIG. 3, and is used in Ethernet networks (see Japanese Patent Laid-Open No. 2000-261479 for example).

In FIG. 3, if a network that permits only client U1 to communicate with server S is to be built, one may contemplate

1. assigning a VLAN (Virtual LAN) or

2. encrypting communications between S and U1. SUMMARY OF THE INVENTION

However, in the case of the first method given above, it is difficult to implement user access control because client U2 can easily participate in the same VLAN.

In the case of the second method, strong security can be built and user access control can be implemented by setting a private key shared by client U1 and server S. However, the method requires expensive equipment because the encryption process using a private key is complex.

In light of these circumstances, an object of the present invention is to provide a user access control method and apparatus capable of implementing inexpensive user access control in a bus network, and a bus network system that implements low-cost security.

To achieve the object, according to a first aspect of the invention, there is provided a user access control method in a bus network system for permitting a client among a plurality of clients connected to the bus network to communicate with a server, wherein a value of an FCS field in an Ethernet frame transmitted between the permitted client and the server is reversibly converted so that the Ethernet frame is converted into an FCS error frame.

According to a second aspect of the invention, the value of the FCS field in the Ethernet frame converted into the FCS error frame and transmitted is restored to the original value in the FCS field.

According to a third aspect of the present invention, a value of the FCS field in an Ethernet frame to be sent to a server by a client permitted to communicate with the server is reversibly converted so that the Ethernet frame is converted into an FCS error frame and the value of the FCS field in the Ethernet frame converted into the FCS error frame and transmitted is restored to the original value of the FCS field before the server receives the Ethernet frame.

According to a fourth aspect of the invention, a value of an FCS field in an Ethernet frame to be transmitted to a server by a client permitted to communicate with the server is reversibly converted so that the Ethernet frame is converted into an FCS error frame and the value of the FCS field in the Ethernet frame converted into the FCS error frame and transmitted is restored to the original value of the FCS field before the client receives the Ethernet frame.

According to a fifth aspect of the invention, the conversion into the FCS error frame is performed by inverting the value of the FCS field.

According to a sixth aspect of the invention, there is provided a user access control apparatus in a bus network system which permits a client among a plurality of clients connected to the bus network to communicate with a server, the apparatus comprising means for reversibly converting a value of an FCS field in an Ethernet frame transmitted between the permitted client and the server so that the Ethernet frame is converted into an FCS error frame.

According to a seventh aspect of the invention, the user access control apparatus includes means for restoring the value of the FCS field in the Ethernet frame, converted into the FCS error frame and transmitted, to the original value of the FCS field.

According to a eighth aspect of the invention, the user access control apparatus is provided on a transmission channel connecting a client permitted to communicate with the server to a bus.

According to a ninth aspect of the invention, the user access control apparatus is provided on a transmission channel connecting a server to a bus network.

According to a tenth aspect of the invention, the conversion into the FCS error frame is performed by inverting the value in the FCS field.

According to an eleventh aspect of the invention, there is provided a bus network system which permits a client among a plurality of clients connected to the bus network to communicate with a server, the system including: an apparatus which reversibly converts a value of an FCS field in an Ethernet frame transmitted between the permitted client and the server so that the Ethernet frame is converted into an FCS error frame; and an apparatus which restores the value of the FCS field in the Ethernet frame, converted into the FCS error frame and transmitted, to the original value of the FCS field.

According to a twelfth aspect of the invention, the conversion into the FCS error frame is performed by inverting the value in the FCS field.

According to the present invention having the features described above, proper server access control can be implemented at a low cost and security can be built at a lower cost by intentionally converting Ethernet frames transmitted and received in a bus network to FCS error frames.

### BRIEF DESCRIPTION OF THE DRAWINGS

FIG. 1 is a block diagram showing an embodiment of the present invention;

FIG. 2 is a block diagram showing an embodiment of an FCS converter shown in FIG. 1; and

FIG. 3 is a block diagram showing an example of the conventional art.

### DETAILED DESCRIPTION OF THE PREFERRED EMBODIMENTS

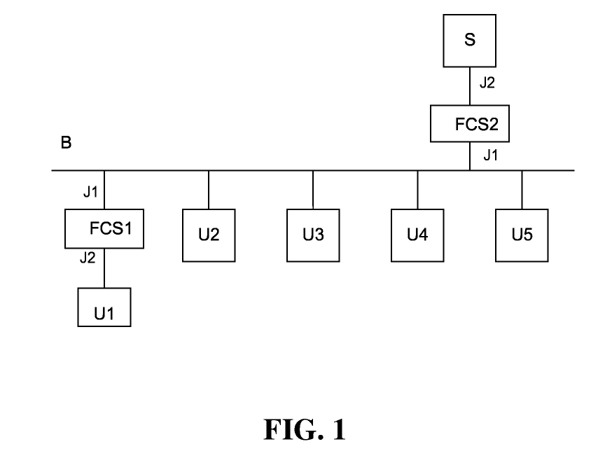

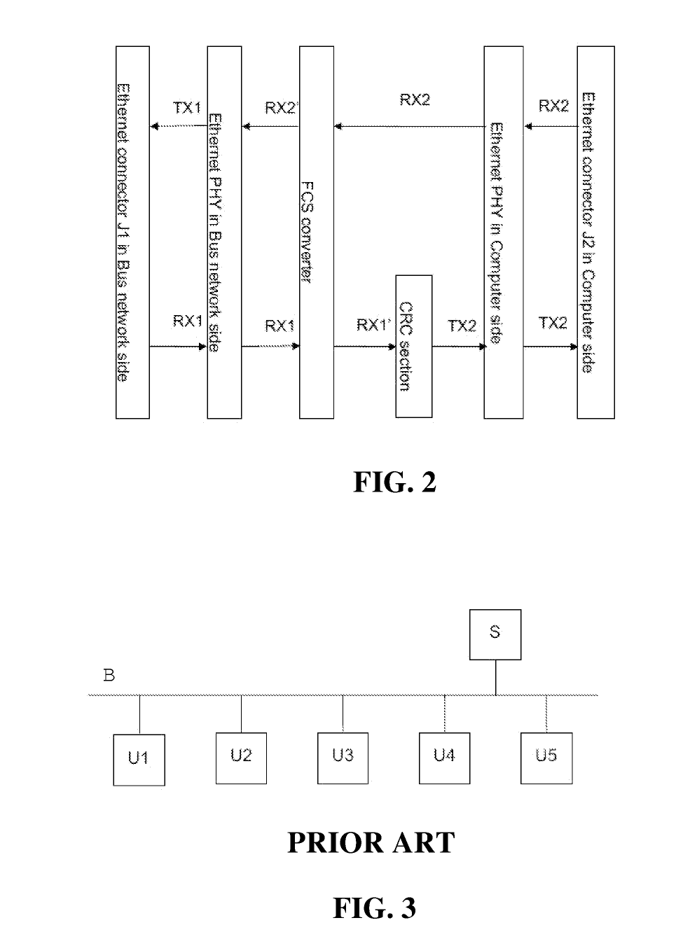

FIG. 1 is a block diagram showing an embodiment of the present invention and FIG. 2 is a block diagram showing a specific embodiment of an FCS converter.

According to the present embodiment, in a bus network in which multiple clients U1 to U5 and one server S are connected to a coaxial cable bus B, only client U1 is to be permitted to communicate with the sever S and FCS (Frame Check Sequence) converters (hereinafter referred to as “FCS 1 and FCS 2”) are provided in a transmission channel connecting client U1 to the bus B and a transmission channel connecting the server S to the bus B, respectively, that include means for reversibly converting a value of an FCS field in an Ethernet frame so that the Ethernet frame is converted into an FCS error frame and means for restoring the value of the FCS field in the Ethernet frame, converted to the FCS error frame and transmitted, to the original value of the FCS field.

When client U1 sends Ethernet frames to server S, a value of the FCS field included in the Ethernet frame is reversibly converted by FCS1 so that the Ethernet frame is converted into an FCS error frame. On the sever S side, FCS 2 restores the FCS field in the Ethernet frame sent through the bus B to the original value of the FCS field. Cyclic Redundancy Check (CRC) may be performed on Ethernet frames and an Ethernet frame that contains an FCS field not converted into an FCS error frame, that is, an Ethernet frame that contains an FCS field to which error frame conversion was not applied, may be discarded before it reaches the server S.

Conversely, when the server S sends an Ethernet frame to client U1, FCS 2 converts the value of the FCS field in the Ethernet frame sent from the server S into an error frame, and FCS 1 converts the error frame back into the FCS field.

The configuration of the FCS converter illustrated in FIG. 2 is common to FCS 1 and FCS 2. Ethernet frames sent from client U1 or the server S (hereinafter genetically named “computer”) are received at Ethernet connector J2 in the computer side and are provided from an Ethernet physical layer IC (Ethernet PHY) through a communication channel RX2 to the FCS converter, where error frame conversion is applied to the frames. Ethernet frames including converted FCS error frames are provided to Ethernet physical layer IC (PHY) in the bus network side through a transmission channel RX2′ and are transmitted from Ethernet connector J1 in the bus network side onto the bus B through a transmission channel TX1.

On the other hand, an Ethernet frame sent through the bus B is received at Ethernet connector J1 in the bus network side, and is provided from the Ethernet physical layer IC (Ethernet PHY) through a transmission channel RX1 to the FCS converter, where the FSC field is restored to the original FCS field. Ethernet frames including reversely converted FCS fields are subjected to CRC check in a CRC section. Then the frames are provided from the CRC section to the Ethernet physical layer IC (Ethernet PHY) through a transmission channel TX2 and is transmitted from Ethernet connector J2 in the computer side to the computer through the transmission channel TX2.

Conversion of an FCS field into an error frame is not limited to a specific method. Any reversible conversion may be used. For example, one preferable mode is to invert the value of the FCS field. Alternatively, EOR (Exclusive OR) logic operation may be used.

In any case, both FCS 1 and FCS 2 know how frames were converted and therefore can perform conversion and reverse conversion corresponding to each other.

By intentionally converting the FCS field in an Ethernet frame into an error frame as described above, access to a server can be limited to users for whom an FCS 1 is provided. Unauthorized access by users for whom an FCS 1 is not provided can be properly inhibited.

An Ethernet frame contains other elements such as a destination address, a source address, and a data frame. According to the present invention, error frame conversion is applied only to the FCS field. Therefore, inexpensive user access control can be implemented as compared with conventional encryption that is applied to data frames.

The present invention also has advantages that individual settings on clients and servers are not required and information specific to each client can be maintained because an FCS field is converted into an error frame simply by inverting the value of the FCS field.

The present invention described above can also be applied to preventing wiretapping on a network from general computers and unauthorized access to network services from unauthorized computers through impersonation.

What is claimed is:

1. A user access control method in a bus network for permitting a client among a plurality of clients connected to the bus network to communicate with a server, wherein a value of an FCS field in an Ethernet frame transmitted between the permitted client and the server is reversibly converted so that the Ethernet frame is converted into an FCS error frame.

2. The user access control method in a bus network according to claim 1, wherein the value of the FCS field in the Ethernet frame converted into the FCS error frame and transmitted is restored to the original value of the FCS field.

3. The user access control method in a bus network according to claim 1, wherein a value of the FCS field in an Ethernet frame to be transmitted to a server by a client permitted to communicate with the server is reversibly converted so that the Ethernet frame is converted into an FCS error frame and the value of the FCS field in the Ethernet frame converted into the FCS error frame and transmitted is restored to the original value of the FCS field before the server receives the Ethernet frame.

4. The user access control method in a bus network according to claim 1, wherein a value of an FCS field in an Ethernet frame to be transmitted to a server by a client permitted to communicate with the server is reversibly converted so that the Ethernet frame is converted into an FCS error frame and the value of the FCS field in the Ethernet frame converted into the FCS error frame and transmitted is restored to the original value of the FCS field before the client receives the Ethernet frame.

5. The user access control method in a bus network according to claim 1, wherein the conversion into the FCS error frame is performed by inverting the value of the FCS field.

6. A user access control apparatus in a bus network which permits a client among a plurality of clients connected to the bus network to communicate with a server, the apparatus comprising means for reversibly converting a value of an FCS field in an Ethernet frame transmitted between the permitted client and the server so that the Ethernet frame is converted into an FCS error frame.

7. The user access control apparatus in a bus network according to claim 6, comprising means for restoring the value of the FCS field in the Ethernet frame, converted into the FCS error frame and transmitted, to the original value of the FCS field.

8. The user access control apparatus in a bus network according to claim 6, wherein the apparatus is provided on a transmission channel connecting a client permitted to communicate with the server to a bus.

9. The user access control apparatus in a bus network according to claim 6, wherein the apparatus is provided on a transmission channel connecting a server to a bus.

10. The user access control apparatus according to claim 5, wherein the conversion into the FCS error frame is performed by inverting the value of the FCS field.

11. A bus network system which permits a client among a plurality of clients connected to the bus network to communicate with a server, the system comprising:
an apparatus which reversibly converting a value of an FCS field in an Ethernet frame transmitted between the permitted client and the server so that the Ethernet frame is converted into an FCS error frame; and
an apparatus which restores the value of the FCS field in the Ethernet frame, converted into the FCS error frame and transmitted, to the original value of the FCS field.

12. The bus network system according to claim 11, wherein the conversion into the FCS error frame is performed by inverting the value of the FCS field.

13. The user access control method in a bus network according to claim 2, wherein a value of the FCS field in an Ethernet frame to be transmitted to a server by a client permitted to communicate with the server is reversibly converted so that the Ethernet frame is converted into an FCS error frame and the value of the FCS field in the Ethernet frame converted into the FCS error frame and transmitted is restored to the original value of the FCS field before the server receives the Ethernet frame.

14. The user access control method in a bus network according to claim 2, wherein a value of an FCS field in an Ethernet frame to be transmitted to a server by a client permitted to communicate with the server is reversibly converted so that the Ethernet frame is converted into an FCS error frame and the value of the FCS field in the Ethernet frame converted into the FCS error frame and transmitted is restored to the original value of the FCS field before the client receives the Ethernet frame.

15. The user access control method in a bus network according to claim 2, wherein the conversion into the FCS error frame is performed by inverting the value of the FCS field.

16. The user access control method in a bus network according to claim 3, wherein the conversion into the FCS error frame is performed by inverting the value of the FCS field.

17. The user access control method in a bus network according to claim 4, wherein the conversion into the FCS error frame is performed by inverting the value of the FCS field.

18. The user access control apparatus in a bus network according to claim 7, wherein the apparatus is provided on a transmission channel connecting a client permitted to communicate with the server to a bus.

19. The user access control apparatus in a bus network according to claim 7, wherein the apparatus is provided on a transmission channel connecting a server to a bus.

20. The user access control apparatus according to claim 6, wherein the conversion into the FCS error frame is performed by inverting the value of the FCS field.

21. The user access control apparatus according to claim 7, wherein the conversion into the FCS error frame is performed by inverting the value of the FCS field.

22. The user access control apparatus according to claim 8, wherein the conversion into the FCS error frame is performed by inverting the value of the FCS field.

23. The user access control apparatus according to claim 9, wherein the conversion into the FCS error frame is performed by inverting the value of the FCS field.
